(19) United States
(12) Patent Application Publication
(10) Pub. No.: US 2006/0101948 A1
(43) Pub. Date: May 18, 2006

(54) Tool for holding a fastener

(76) Inventors: Robert Meitzler, Franklin, TN (US); Jared Meitzler, Spring Hill, TN (US)

Correspondence Address: STITES & HARBISON PLLC, 424 CHURCH STREET, SUITE 1800, NASHVILLE, TN, 37219-2376, US

(21) Appl. No.: 11/274,777

(22) Filed: Nov. 14, 2005

Related U.S. Application Data
(60) Provisional application No. 60/627,991, filed on Nov. 15, 2004.

(51) Int. Cl. B25C 3/00

(52) U.S. Cl. 81/44; 81/487

(57) ABSTRACT

Disclosed herein is a tool for holding a fastener, such as a nail, screw, bolt or the like. The tool includes a handle attached to a mounting head that is specifically shaped to correspond with the shape of a fastener. Between the mounting head and the handle can be a bend that facilitates proper grasping of the handle by the hand of a user of the tool. The mounting head includes an engaging location defined by at least one locating guide. The engaging location can be an aperture or gap that substantially conforms to the shape of the fastener. The tool also includes at least one magnet to removably hold the fastener in the aperture. The tool can include a sleeve that can act as a grip, or protect the hand of a user from vibrational and electrical energy during use of the tool.

### CROSS REFERENCES TO RELATED APPLICATIONS

This application claims priority from U.S. Application Ser. No. 60/627,991 filed on Nov. 15, 2004, the entire disclosure of which is incorporated herein by this reference.

### FIELD OF THE INVENTION

The present invention relates generally to hand tools. More specifically, the present invention relates to a tool for holding a nail, screw, or similar fastener while a user implements the fastener into a fastened position.

### BACKGROUND OF THE INVENTION

Fasteners like screws, nails, bolts, tacks, staples, and the like are commonly used to join two materials such as wood or metal together. Using a fastener usually requires holding the fastener in the fingers of one hand and an application tool in the other. Before the fastener can be released, it must sufficiently engage the material in which it is being implemented such that the material holds the fastener in place. This can be an awkward and dangerous process. For instance, the soft tissue of the hand makes accurately guiding a rigid fastener awkward and difficult. Furthermore, and particularly in the case of striking application tools such as hammers, improper handling of the application tool could easily injure the fingers holding the fastener.

While other inventions have addressed some of the concerns raised here, most address these problems in a complex or a specific manner. For instance, many of the inventions of the prior art comprise complex moving parts, such as a pliers-type device (U.S. Pat. No. 4,221,248) or a sleeve-type screw holder (U.S. Pat. No. 5,507,209), and are therefore difficult to manufacture and require more maintenance. Others, address only a specific concern, such as a nail-holder that attaches to the head of a hammer (U.S. Pat. No. 4,658,679), or a screw holder that attaches to the finger of a user (U.S. Pat. No. 4,256,157). Therefore, there remains a need in the art for a simple, versatile, safe, and effective tool for holding a fastener.

It is therefore an object of the present invention to provide a tool for holding a fastener that easily, safely, securely, and economically holds a wide range of fasteners.

These and other objects and advantages of the present invention will become apparent upon a reading of the following description.

### SUMMARY OF THE INVENTION

The present invention meets the above identified needs, and others, by providing a simple tool for holding a wide range of fasteners such as a nails, screws, staples or the like. In an exemplary embodiment the new tool includes a handle that leads to a mounting head. In embodiments of the present invention, the mounting head is shaped to receive a range of different fasteners. Between the mounting head and the handle can be an optional bend that facilitates grasping of the handle by the hand of a user of the tool.

In other embodiments of the present invention, the mounting head includes an engaging location defined by at least two locating guides. The engaging location, in combination with the locating guides, creates an gap or aperture that substantially conforms to the shape of a fastener. The mounting head also includes at least one magnet to removably hold the fastener in the engaging location. Additionally, the tool can include a sleeve capable of insulating the hand of a user from both vibrational and electrical energy during use of the tool while simultaneously providing a gripping surface.

### DESCRIPTION OF THE DRAWINGS

FIG. 1 is a perspective view of a tool for holding a fastener made in accordance with the present invention.

FIG. 2 is a partial perspective view of the tool of FIG. 1 showing the tool holding a screw-type fastener.

FIG. 3 is a partial perspective view showing a user implementing a nail-type fastener by utilizing the tool of FIG. 1.

### DETAILED DESCRIPTION OF THE INVENTION

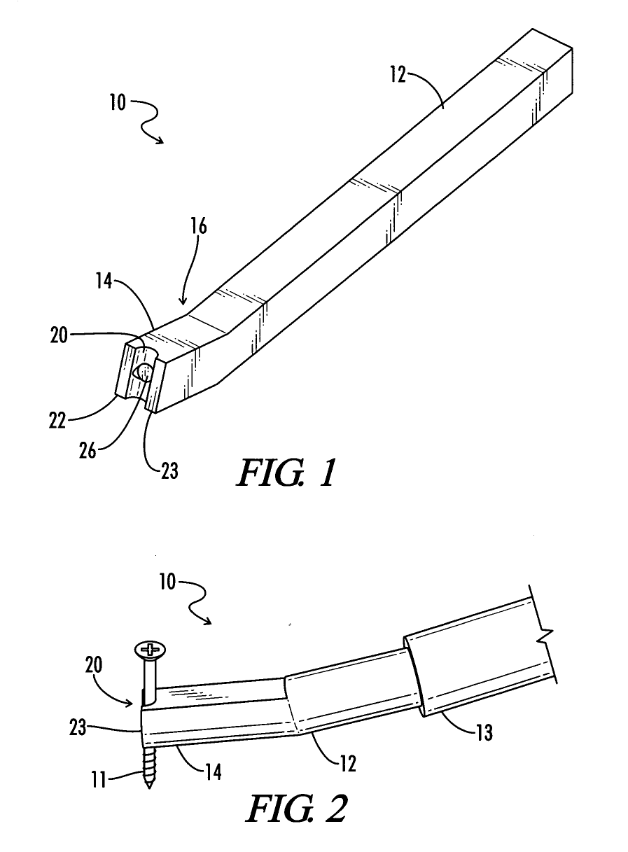

Referring now to FIG. 1 and 2, a tool 10 for holding a fastener is generally disclosed. The tool 10 is for the implementation of a fastener 11, such as a nail, screw, or the like. The tool 10 comprises an arm/handle/body portion 12 that includes a mounting head 14 adapted to securely hold a fastener 11.

Turning now to FIG. 1, the mounting head 14 includes an engaging location 20 defined by at least one locating guide 22 and 23. The locating guides 22 and 23 can define an engaging location 20 (shown as a gap 20 in FIG. 1), or an aperture (not shown). In these embodiments, the length and angle of the locating guides 22 and 23 can vary depending on the size, shape, and type of fastener used. As shown in the embodiment depicted in FIG. 2, the tool 10 can include two locating guides 22 and 23 of substantial enough length to form a gap 20 that generally conforms to the shape of the fastener 11. In another embodiment, the two locating guides 22 and 23 may also be of substantial enough length to form an aperture (not shown) that substantially encloses a fastener 11. In still yet another embodiment, the tool 10 can have a single locating guide (not shown) that forms an aperture that substantially encloses a fastener 11. Generally speaking, the exact nature of the locating guide is not critical, as its function is to assist the fastener in a plane that is readily engaged by a fastening tool.

Turning back to FIG. 1, to facilitate holding the fastener 11 in place, at least one magnet 26 is positioned in or on the tool 10. The magnet 26 is used to engage and removably hold the fastener 11 in the engaging location 20. While in the exemplary embodiment 10 the magnet 26 is embedded within the mounting head 14, it can also be positioned as a strip along the locating guides 22 and 23. Alternately, the mounting head 14, or the entire tool 10 can be magnetized. The purpose of the magnet is to attract and hold the fastener to the tool.

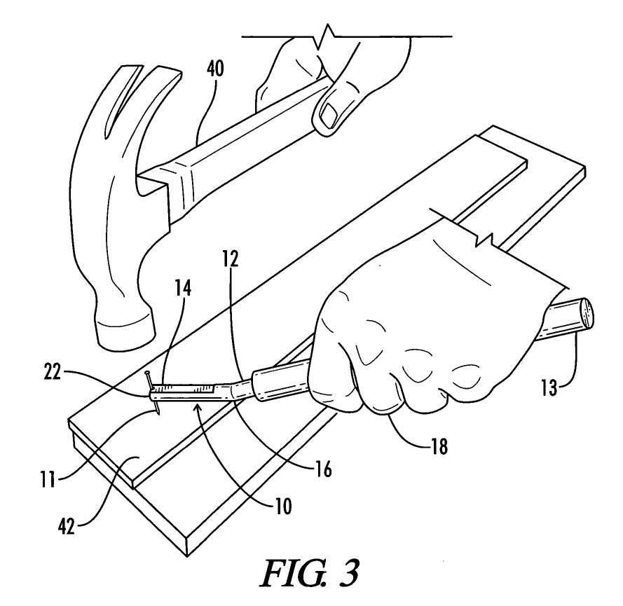

Turning to FIG. 3, in the exemplary embodiment the handle 12 is sized to accommodate the hand 18 of a user. The handle 12 can be straight or connected to the mounting head 14 at a bend 16 as in the exemplary embodiment 10. The angle of the bend 16 connecting the handle 12 to the mounting head 14 in each particular embodiment, depends on the application. For instance, the angle of the bend 16 connecting the handle 12 to the mounting head 14 could render the handle 12 generally perpendicular to the mounting head 14 such that a fastener 11 can be held in a small space. On the other hand, FIG. 3 shows that the bend 16 in the exemplary embodiment 10 is of such an angle in relation to the mounting head 14 that a user can implement the fastener 11 while leaving room for the fingers of the hand 18 under the handle 12. In the exemplary embodiment, the handle 12 and the mounting head 14 are made from a single piece of rigid material, such as aluminum or plastic, but the handle 12 and mounting head 14 can each be made from different materials, as well.

The handle 12 of the tool 10, can also include a sleeve 13. The sleeve 13 can be a grip 13, and can be comprised of a material suited to insulate the hand 18 of a user from vibrations of an application tool 40 on the tool 10. The sleeve may also be made of a material that does not conduct electricity thereby beneficially protecting the hand 18 of a user from electrical current that would normally run through the tool 10.

To use the tool 10, the user engages a fastener 11 with the magnet 26 such that the fastener 11 is securely and removably held in position in the engaging location 20. In the exemplary embodiment 10, this comprises engaging a fastener 11 with the magnet 26 embedded in the mounting head 14. The user then grips the handle 12 of the tool 10 with one hand 18, and holds the tool 10 such that the fastener 11 is held in a position beneficial for implementation. The user then implements the fastener with an application tool 40, which can be a hammer as in FIG. 3, a screwdriver, or other tool useful for implementing the particular fastener 11. When necessary, the user removes the tool 10 when the fastener 11 has sufficiently engaged the material 42 in which it is being implemented such that the material 42 holds the fastener in place while completing the implementation.

One of ordinary skill in the art will also recognize that additional embodiments are possible without departing from the teachings of the present invention or the scope of the claims which follow. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A tool for holding a fastener comprising:
an arm that includes a mounting head;
a magnet to attract and hold a fastener to the mounting head in a position that allows it to be applied to a material.

2. The tool of claim 1, wherein the mounting head comprises at least one locating guide.

3. The tool of claim 2, wherein the locating guide helps define a receiving space to receive and hold the fastener in a position to be engaged by an application tool.

4. The tool of claim 2, wherein the locating guide forms an aperture.

5. The tool of claim 1, wherein the mounting head comprises the magnet.

6. The tool of claim 1, wherein the magnet is embedded in the mounting head.

7. The tool of claim 3, wherein the magnet is positioned in the receiving space.

8. The tool of claim 1, further comprising a sleeve arranged around the arm.

9. The tool of claim 8, wherein the sleeve is comprised of a material suited to insulate the hand of a user from vibrations of an application tool on the tool.

10. The tool of claim 8, wherein the sleeve is comprised of a material suited to insulate the hand of a user from electrical current.

11. The tool of claim 8, wherein the sleeve comprises a gripping surface.

12. The tool of claim 1, wherein the fastener is a nail.

12. A method of applying a fastener, comprising the steps of:
providing a tool that has an arm with a mounting head, wherein the mounting head attracts and holds a fastener at an engaging location;
attaching a fastener to the engaging location, gripping the arm of the tool;
holding the tool such that the magnet secures the fastener in a position beneficial for implementation; and
implementing the fastener with an application tool.

13. The method of claim 13, further comprising the step of removing the tool when the fastener has sufficiently engaged the material in which it is being implemented such that the material holds the fastener in place.
